(19) United States
(12) Patent Application Publication
(10) Pub. No.: US 2009/0164575 A1
(43) Pub. Date: Jun. 25, 2009

(54) METHOD AND SYSTEM FOR THE ESTABLISHMENT OF COMPLEX NETWORK TELEPRESENCE CONFERENCE

(75) Inventors: Louis Barbeau, Saint-Bruno de Montarville (CA); Andre Moskal, Kanata (CA); Francois Gariepy, Westmount (CA)

Correspondence Address: Nixon Peabody LLP, 200 Page Mill Road, Palo Alto, CA, 94306, US

(73) Assignee: HAIVISION SYSTEMS INC., Montreal (CA)

(21) Appl. No.: 12/323,420

(22) Filed: Nov. 25, 2008

Related U.S. Application Data
(60) Provisional application No. 60/990,180, filed on Nov. 26, 2007.
(60) Provisional application No. 60/990,645, filed on Nov. 28, 2007.

(51) Int. Cl. G06F 15/16

(52) U.S. Cl. 709/204; 709/227; 709/231

(57) ABSTRACT

A system and a method for dynamic establishment of telepresence conferences using standard protocol, such as SIP, for communications are provided. The method provides for negotiation of profiles of each location participating at the telepresence conference. The profiles provide information on the connectivity, positioning and configuration of the audiovisual elements, number of participating sites and number of participants at each location. These profiles are derived from the set of sites participating into the telepresence conference and their capabilities which are acquired through a dynamic scheme during the telepresence conference initiation.

### RELATED APPLICATION

The present application claims priority of U.S. provisional patent application No. 60/990,645 filed on Nov. 28, 2007, the specification of which is incorporated herein by reference.

### FIELD OF THE INVENTION

This application relates in general to the delivery of telepresence services and, in particular, to a method and system for establishing signaling and media flow to facilitate the provisioning and establishment of the telepresence services in a dynamic fashion.

### BACKGROUND OF THE INVENTION

Telepresence has been considered as a use of communications technology to provide each user participating in the telepresence conference with the feeling that other users located at remote site are locally present.

There are today a certain number of telepresence service providers whose networks of rooms are entirely separate and cannot interoperate with each others. These offerings are high-end systems that use multiple, direct point-to-point interconnections to meet their needs and as such can provide the best possible telepresence experience.

The network operators utilizing such solutions have their own proprietary network controller that, at end user request, is setting the multitude of streams that have to flow between each room participating in the telepresence conference. The data and the intelligence required to setup these networks reside in specialized systems called network controllers. The logic residing in network controllers is quite complex given the diversity of room configurations, e.g. number and position of cameras and displays, that have to be supported and the more dynamic aspect of conferencing like the number of attendees in a given room for a given conference. These solutions utilizing proprietary network controllers are extremely difficult to configure in the telepresence equipment multi vendor environments.

Therefore, there is a need for a method and a system that can be used to establish complex telepresence connectivity using standard protocol for connectivity that enables interoperability with multi vendor solutions.

### BRIEF SUMMARY

It is an object of the invention to provide a system for dynamic establishment of telepresence conferences that satisfies the above-mentioned need.

Accordingly, there is provided a system for establishing a multi-stream video conference between a plurality of locations interconnected with a data network. The system comprises a plurality of local encoding means, each being respectively associated with a corresponding one of the plurality of locations for streaming a corresponding audiovisual signal towards at least one other location. Each of the encoding means provides a first configuration indication on an available configuration of the associated location. The system also comprises a plurality of local decoding means, each being respectively associated with a corresponding one of the plurality of locations for processing an incoming audiovisual stream from another location. Each of the decoding means provides a second configuration indication on the available configuration of the associated location.

The system also comprises a plurality of room controllers, a corresponding one of the controllers being associated with each corresponding location respectively. The plurality of room controllers comprises a conference initiating room controller adapted for receiving an indication of a selected set of locations to be interconnected and for communicating with at least one of the encoding means and the decoding means associated with each of the locations selected to receive the configuration indications of the associated location. The conference initiating room controller is further adapted to determine a suitable point-to-point network configuration based on the configuration indications for providing each of the remaining room controllers with at least a part of the configuration. Each of the room controllers is adapted to control at least one of the corresponding local encoding means and decoding means of the associated location according to the suitable configuration so as to establish the video conference according to the suitable point-to-point network configuration.

It is another object of the invention to provide a method for dynamic establishment of telepresence conferences.

Accordingly, there is provided a method for establishing a multi-stream video conference between a plurality of locations, the method comprising providing a room controller at each of the plurality of locations, each room controller controlling at least one of at least one local encoder for streaming an audiovisual signal towards at least one other location and at least one decoder for processing an incoming audiovisual stream from another location wherein the room controllers are interconnected using a data network; configuring a conference initiating room controller, the configuring comprising providing an indication of a selected set of locations to be interconnected; the conference initiating room controller receiving an indication of at least one of the corresponding at least one local encoder and the corresponding at least one local decoder associated with each location of the selected set of locations to be interconnected using the data network; determining a suitable point-to-point network configuration between the corresponding at least one local encoder available and the corresponding at least one decoder available for each of the controllers of the selected set of locations; providing each room controller of the selected set of locations with at least one part of the configuration; each room controller of the selected set of locations configuring at least one of their respective local encoders and decoders in accordance with the configuration and establishing the video conference according to the suitable point-to-point network configuration.

According to another aspect of the invention, there is also provided a computer readable medium comprising computer readable instructions for causing a processing unit to carry out the above-described method.

### BRIEF DESCRIPTION OF THE DRAWINGS

These and other objects and advantages of the invention will become apparent upon reading the detailed description and upon referring to the drawings in which:

FIG. 1 is a schematic representation of a system for establishing a multi-stream video conference between a plurality of locations, according to an embodiment of the invention;

FIG. 2 is a schematic representation of another system for establishing a multi-stream video conference between a plurality of locations, according to another embodiment of the invention;

FIG. 3 is a block diagram of a room controller provided with integrated encoding means and decoding means;

FIG. 4 shows data formats for the room capabilities and for the room profile used during the dialog establishment phase between the room controllers, in accordance with one embodiment of the invention;

FIGS. 5A to 5B represent a flow diagram showing an overview of the tasks performed by the room controllers while providing multi-point telepresence conference establishment;

FIGS. 6A to 6C represent a message flow diagram schematically illustrating principle messages exchanged between the components of the systems illustrated in FIG. 1 and FIG. 2 in providing multi-point telepresence conference establishment, in accordance with one embodiment of the invention; and

FIG. 7 is a flowchart showing one embodiment of a method for establishing a multi-stream video conference between a plurality of locations, in accordance with the invention.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

The present invention is directed to a system and a method for establishing a multi-stream video conference between a plurality of locations. As it will be more clearly understood upon reading of the present description, the method disclosed advantageously provides for negotiation of room profiles of each location participating at the telepresence conference. The conference profile, or configuration, developed according to the number of sites involved and of their specific capabilities, provides, in one embodiment, information on the connectivity, positioning and configuration of the audiovisual elements, number of participating sites and number of participants at each location. As it will be more detailed thereinafter, the room profiles are derived from the general conference profile which is developed dynamically as part of the conference setup and distributed to the connecting network elements in a dynamic fashion during telepresence conference initiation.

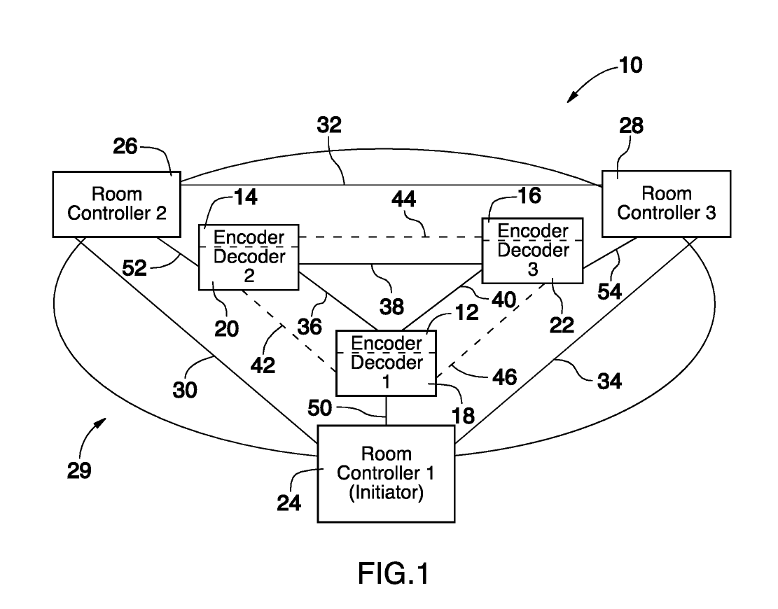

Referring to FIG. 1, there is shown a system 10 for establishing a multi-stream video conference between three locations, according to an embodiment of the invention. The system 10 comprises three local encoding means 12, 14, 16, each being respectively associated with a corresponding one of the plurality of locations for streaming a corresponding audiovisual signal towards at least one other location. Each location may be provided with several audiovisual devices (not shown). In this case, the encoding means 12, 14, 16 may comprise a single encoder adapted for receiving several types of media streams incoming from the audiovisual devices. Alternatively, the encoding means 12, 14, 16 may be provided with a plurality of encoders, each being associated with a corresponding audiovisual device. In the case where there is a single audiovisual device available for the location, a single encoder is advantageously provided. Each of the encoding means provides a first configuration indication on an available configuration of the associated location, as it will be more clearly described thereinafter.

The system 10 also comprises three local decoding means 18, 20, 22, each being respectively associated with a corresponding one of the plurality of locations for processing an incoming audiovisual stream from another location. As for the encoding means 12, 14, 16, the decoding means 18, 20, 22 may comprise a single decoder or a plurality of decoders. Each of the decoding means 18, 20, 22 provides a second configuration indication on the available configuration of the associated location, as it will be more clearly described thereinafter.

Still referring to FIG. 1, the system 10 also comprises three room controllers 24, 26, 28, a corresponding one of the controllers being associated with each corresponding location respectively. The set of room controllers 24, 26, 28 comprises a conference initiating room controller 24 adapted for receiving an indication of a selected set of locations to be interconnected and for communicating with at least one of the encoding means 12, 14, 16 and the decoding means 18, 20, 22 associated with each of the locations selected to receive the configuration indications of the associated location. In the illustrated embodiment, the conference initiating room controller 24 is one of the controllers 24, 26, 28 associated with a corresponding selected location. In other words, a single room controller is designated as an initiator of the telepresence conference while the other room controllers can be viewed as invited participants. However, the skilled addressee will appreciate that other arrangements wherein the conference initiating room controller is an additional controller may be considered.

The conference initiating room controller 24 is further adapted to determine a suitable point-to-point network configuration based on the configuration indications for providing each of the remaining room controllers 26, 28 with at least a part of the configuration. Each of the room controllers 24, 26, 28 is adapted to control at least one of the corresponding local encoding means 12, 14, 16 and decoding means 18, 20, 22 of the associated location according to the suitable configuration so as to establish the video conference according to the suitable point-to-point network configuration.

In this embodiment, each room controller 24, 26, 28 is a standalone room controller integrated in a separate physical unit that communicates with the corresponding encoding means 12, 14, 16 and decoding means 18, 20, 22 through proprietary or standard means 50, 52, 54, such as the Session Initiated Protocol (SIP) for a non-limitative example, but the skilled addressee will appreciate that other arrangements may be considered. The room controllers 24, 26, 28 are inter-connected through a data network 29 using the signaling protocols 30, 32, 34 used for establishment of dialog. Preferably, the data network 29 comprises the Internet but other data networks may be envisaged. The encoding means 12, 14, 16 and decoding means 18, 20, 22 are interconnected by the signaling protocols 36, 38, 40 used for establishment of media session. The protocol intended to be used for this purpose is Session Initiation Protocol. In addition, media streams 42, 44, 46 flow between each encoding means 12, 14, 16 and decoding means 18, 20, 22 carrying audiovisual information over the Internet Protocol network 29. Typically, and as previously mentioned, one room controller is designated as the conference initiator. In this embodiment, the room controller 24 is an initiator of the telepresence conference.

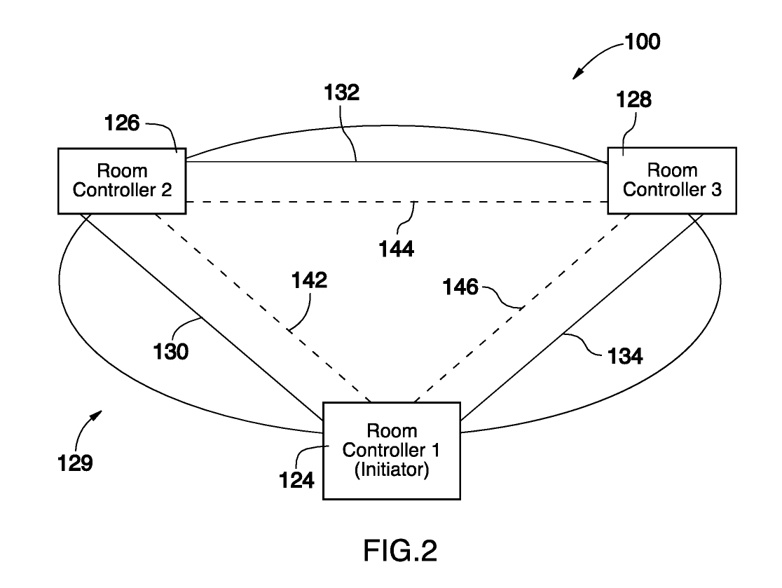

Referring now to FIG. 2, there is shown another embodiment of the system. The system 100 is provisioned with three participating room controllers 124, 126, 128 that are integrated with encoding means and decoding means in a single physical unit. The room controllers 124, 126, 128 are inter-connected using signaling protocols 130, 132, 134 used for establishment of dialog and media session. As previously mentioned, the protocol intended to be used for this purpose is preferably Session Initiation Protocol. In addition, media streams 142, 144, 146 flow between each room controller 124, 126, 128 carrying audiovisual information over the Internet Protocol network 129. In this embodiment, the room controller 124 is an initiator of the telepresence conference.

For simplification purpose, the system of the invention has been described with three room controllers connecting three locations but the skilled addressee will appreciate that any number of locations may be connected provided that they are each provisioned with a corresponding room controller.

It will be appreciated that two distinct telepresence conference models may exist, i.e. a multi-point model forming a mesh network where each location communicates and establishes media streams with every other location participating in the telepresence conference and a star or hub model where each participating location communicates with the central location for inclusion as a participant of the broadcasting conference.

It will be more clearly understood upon the detailed description of the method of the present invention thereinafter that the communication method may be viewed as comprising a two-phase approach, wherein the room controllers provide a first phase comprising peer-to-peer dialog establishment between all participating locations and a secondary phase involving encoders and decoders to establish media streams between all participating encoders and decoders.

It will be appreciated that in order to establish media connectivity, proper positioning and selection of audiovisual equipment as well as a dynamic room profile negotiation takes place between the room controllers. This is referred to as a dialog establishment.

Upon successful dialog establishment, the encoders and decoders configured and selected by the conference initiating room controller establish media streams among themselves. The establishment of the media streams may be accomplished either directly by the encoders and decoders, typically in the standalone room controller network model, or it can be established by the room controller function on behalf of encoders and decoders in the integrated room controller network model.

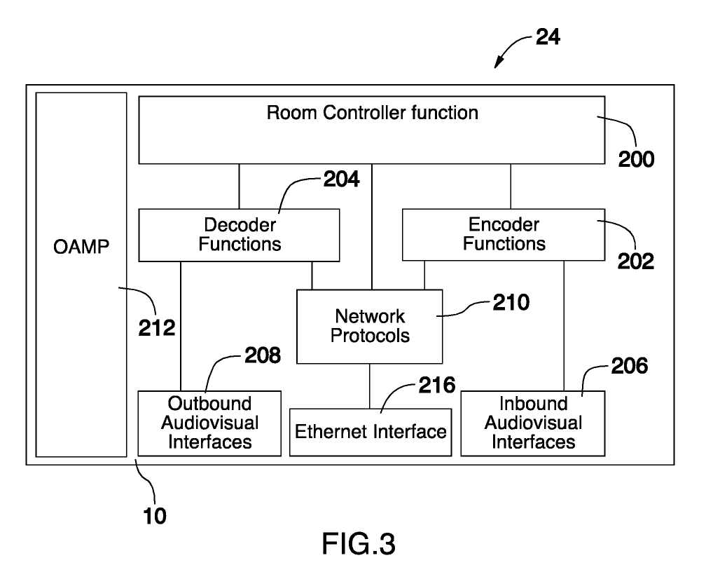

Now referring to FIG. 3, there is shown an embodiment of a room controller 24 provided with integrated encoding means and decoding means for multi-point telepresence conference establishment.

The room controller 24 comprises a room controller function 200 that provides the logic for dialog and session establishment. The room controller function 200 communicates with encoder and decoder functions 202, 204 for configuration management and Network Protocols 210 for communication with another room controller or encoder or decoder functions.

The Network Protocols 210 use Ethernet Interface 216 in a manner known in the art in one embodiment. The encoder function 202 also interfaces with the Network Protocols 210 in a manner known in the art to send out media streams over the network and, in addition, interfaces with Inbound Audiovisual Interfaces 206 in order to receive incoming audio and video signals from connected microphones and cameras (not shown). The decoder function 204 also interfaces with the Network Protocols 210, in a manner known in the art, to receive media streams from the network and, in addition, interfaces with Outbound Audiovisual Interfaces 208 in order to transmit audio and video to connected speakers and displays (not shown). The room controller 24 also comprises an OAMP function 212 i.e. one that provides operational, administrative, management and provisioning to the room controller 24 in a manner known in the art.

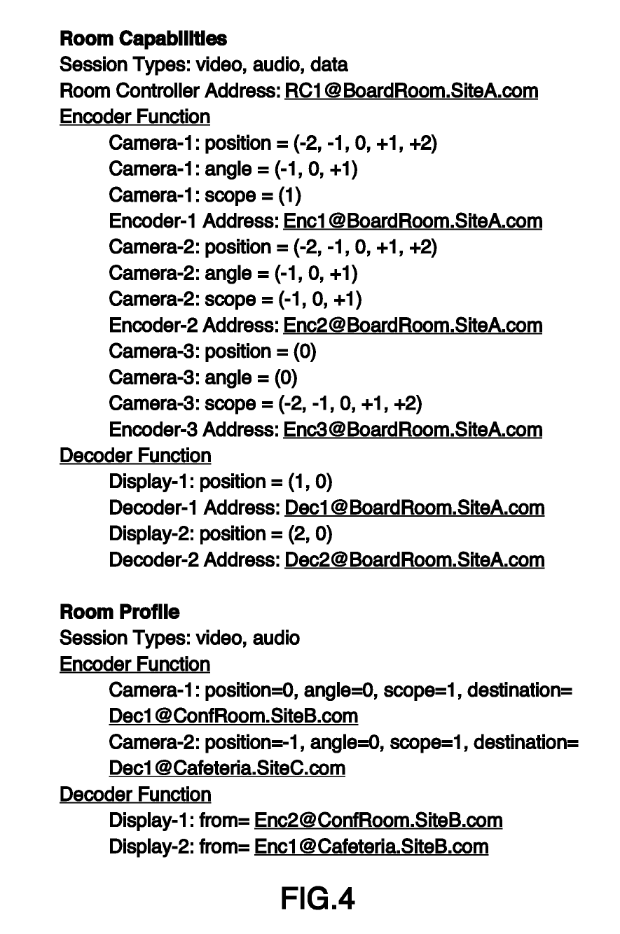

Now referring to FIG. 4, there is shown an example of a data format for the room capabilities used during the dialog establishment phase between the room controllers. The room capabilities are provided by the corresponding room controllers to the conference initiating room controller and are attached to the messages used by the Dialog Setup Protocol, typically Session Initiation Protocol, where room capabilities are attached as the Session Description Protocol information. In one embodiment, the following information elements are included in the room capabilities: number of cameras available and for each their respective level of adjustment capabilities with respect to position, angle and scope, the available displays with their position, the address of the associated encoders and decoders, and the type of media session supported (i.e. video, audio, data, etc). The skilled addressee will appreciate that various other information elements may be provided in the room capabilities.

Still referring to FIG. 4, an example of a data format for the room profile used during the dialog establishment phase between the room controllers is also shown. The room profile is provided by the conference initiating room controller to the remaining room controllers and is also attached to the messages used by the dialog setup protocol, typically Session Initiation Protocol, where room profile is attached as the Session Description Protocol information. In one embodiment, the following information elements are included in the Room profile: the position, angle and scope settings for each camera involved, the addresses of the destination decoders to which the local encoders will stream their data and the addresses of the remote encoders from which the local decoders will receive streaming data. The skilled addressee will appreciate that various other information elements may be provided in the room profile.

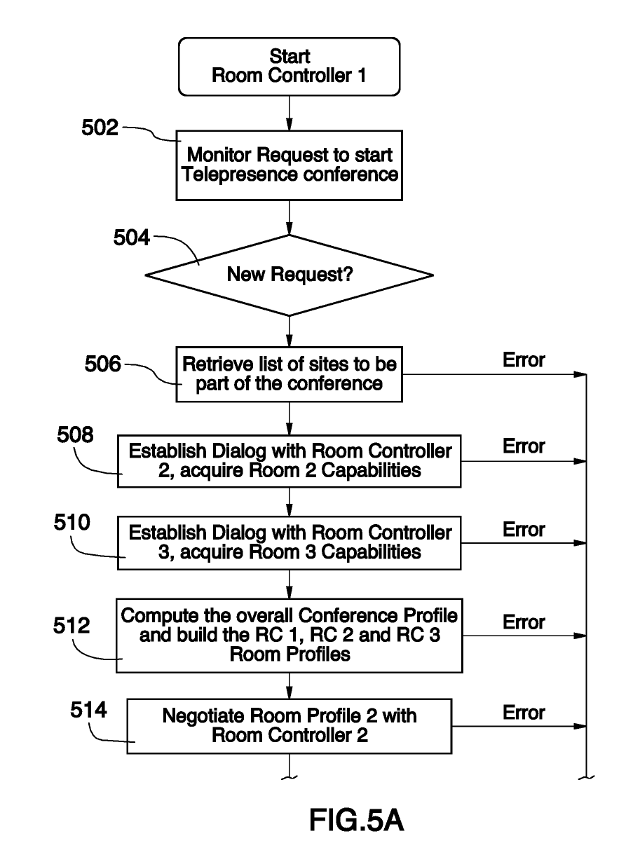

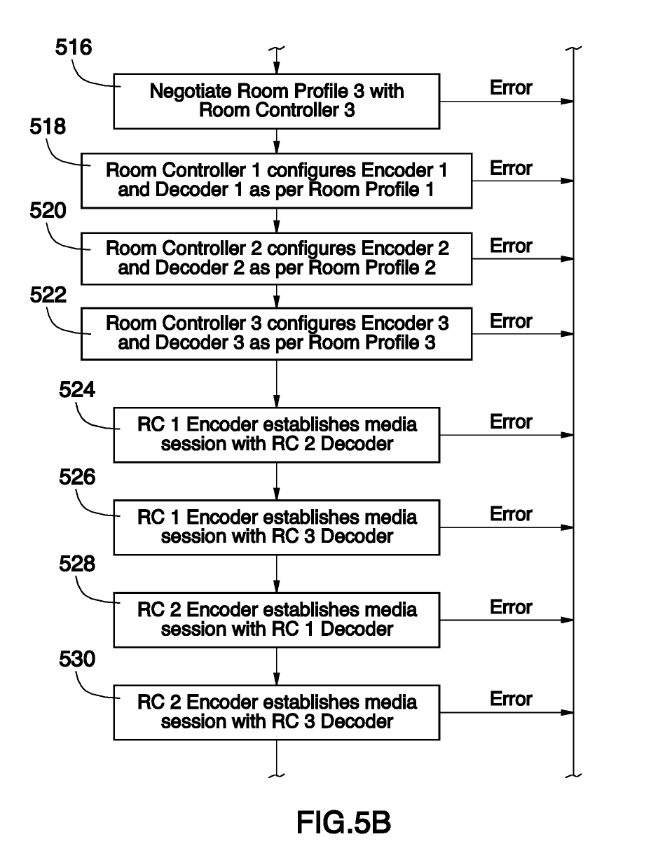

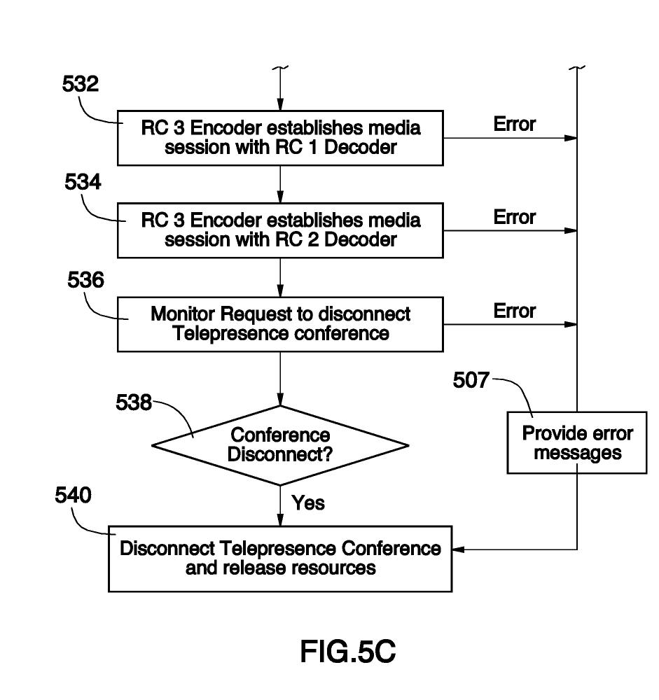

Now referring to FIGS. 5A and 5B, there is shown one embodiment of the tasks performed by the conference initiating room controller 1 while providing a multi-point telepresence conference setup. According to processing step 502, the room controller 1 monitors a request to start a new telepresence conference.

According to processing step 504, a test is performed to find out if this is a new telepresence conference request. In the case where the request is a new request for a telepresence conference and according to processing step 506, the room controller 1 retrieves the list of sites to be involved in the conference.

According to processing step 508, a dialog is established by the conference initiating room controller 1 and the room capabilities are acquired from room controller 2. According to processing step 510, a dialog is established by the conference initiating room controller 1 and the room capabilities are acquired from room controller 3.

According to processing step 512, the conference initiating room controller 1 computes the “best” configuration given the number of sites and their capabilities and derives for each room controller 1, 2, 3 a room profile. Preferably, in order to compute the best configuration, the following key parameters of each room may be taken into consideration: the number of participants and associated clustering information, the number of camera and associated desired Field of View (FoV) for each camera for each cluster of participants, the number of displays and total FoV from center participant location, computer graphics sharing (or not), the number of microphone pick-up points, the type of echo cancelling (single point or multiple points), the number of speakers, etc. The skilled addressee will nevertheless understand that other parameters may be considered.

According to processing step 507 whenever a transaction is not successful or an error occurs, appropriate error messages are provided, the conference is disconnected and the tied resources released.

According to processing steps 514 and 516, the conference initiating room controller 1 negotiates respectively with room controller 2 and room controller 3 their room profile made of camera configurations (FoV-Zoom for each camera), display configuration (blackout areas), microphone configuration (echo cancelling balance and relative audio level balance), speaker configuration (L-R or surround) and computer graphics allocation as non-limitative examples.

According to processing steps 518, 520 and 522, each room controller 1, 2, 3 configures their own resources according to their room profile.

It will be appreciated by the skilled addressee that at this point the first phase of the multi-point telepresence conference establishment is completed and all participating room controllers are ready to establish media sessions.

According to processing steps 524 to 534, the encoding means of each of the room controllers establishes media sessions with the remote decoders as per their room profile.

The method is consistent with the network model that includes integrated room controller function disclosed in FIG. 2 or the standalone room controller disclosed in FIG. 1.

According to processing step 536, the conference initiating room controller detects or monitors for a request to disconnect the conference. In the case where the disconnect request is provided though user interface or other means and according to processing step 540, the conference initiating room controller disconnects the telepresence conference and releases the resources.

It will be appreciated that failure to establish a dialog or media session between the conference initiating room controller and other participating room controllers will lead to the conference being disconnected.

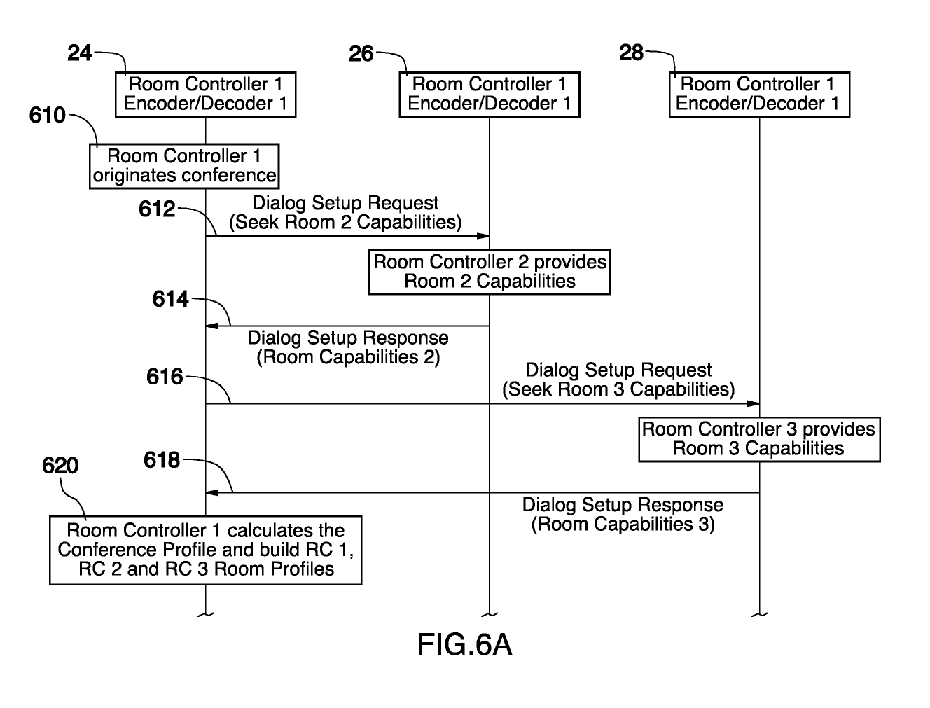

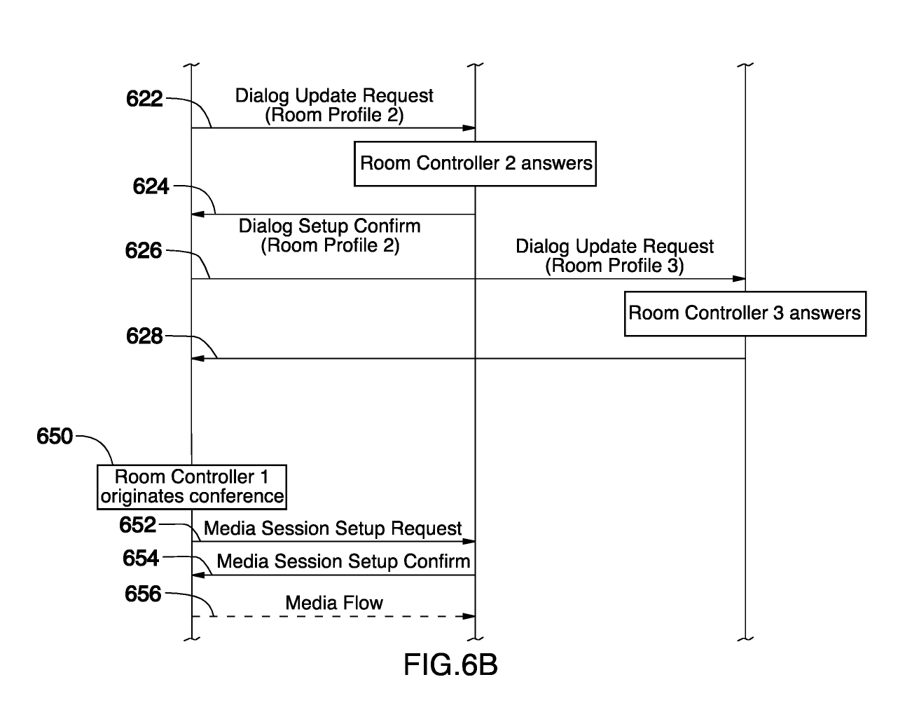

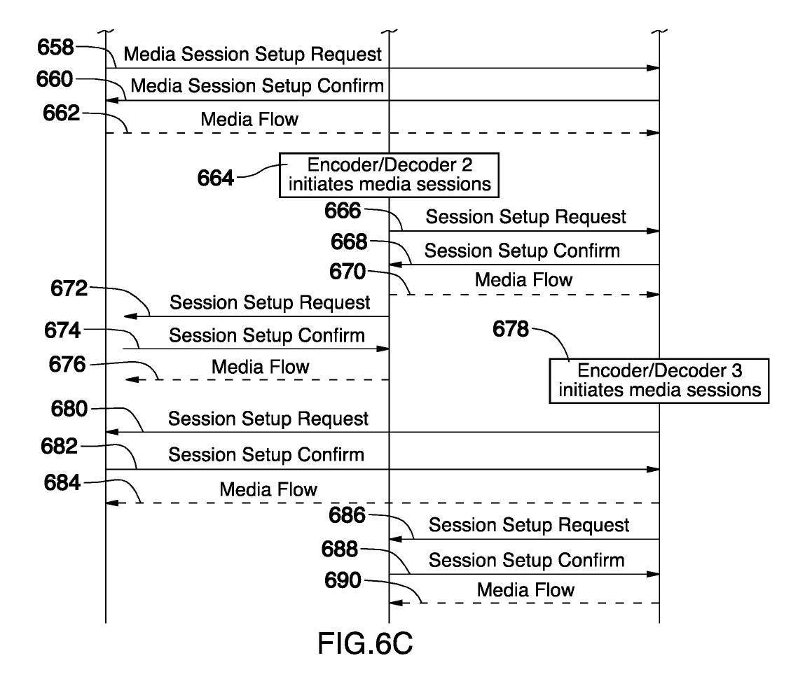

Now referring to FIGS. 6A to 6C, there is shown a diagram schematically illustrating messages exchanged between network components shown in FIGS. 1 and 2 during a multi-point telepresence conference establishment in accordance with one embodiment.

In this embodiment, three room controllers 24, 26, 28 and their associated encoder and decoder are involved, i.e. the conference initiating room controller 24 and its associated encoder 12 and decoder 18; the second room controller 26 and its associated encoder 14 and decoder 20 and the third room controller 28 and its associated encoder 16 and decoder 22.

Upon reception of the request to initiate the telepresence conference, the conference initiating room controller 24 originates the conference 610 by sending a Dialog Setup Request message 612 to the room controller 26 seeking the room controller 26 room capabilities.

In turn, room controller 26 provides its room capabilities by responding with a Dialog Setup Response message 614 with an attached room capabilities.

According to processing steps 616 and 618 the conference initiating room controller 24 then acquires the room controller 28 room capabilities through the same type of Dialog Setup Request and Response transactions.

At processing step 620, the conference initiating room controller 24 computes the best overall conference configuration and derives room profiles for each of the room controllers involved.

The conference initiating room controller 24 negotiates with room controller 26 its room profile. This is performed through the Request Update 622 and Request Confirmation 624 messages. The room controller 26 is now informed about its required configuration through its room profile attached to the Dialog Update message.

According to message transactions 626 and 628, the conference initiating room controller achieves the same configuration negotiation and information transfer with room controller 28.

It will be appreciated by the skilled addressee that at this point the first phase of the multi-point telepresence conference establishment is completed and all participating room controllers 24, 26, 28 are ready to establish media sessions.

The room controller 24 initiates media session 650 with the room controller 28 by sending a Media Session Setup Request message 652. The information regarding media session is attached to the message in a manner known in the art. Upon reception of the message 652, the room controller 26 responds with a Media Session Setup Confirm message 654 and the media flows 656 is established between the encoder of room controller 24 and the decoder of room controller 26. The room controller 24 then proceeds the same way with room controller 28 with message transactions 658 and 660, providing for the media establishment 662.

The room controller 26 initiates media session 664 with the room controller 28 by sending Media Session Setup Request message 666. The information regarding media session is attached to the message in a manner known in the art. Upon reception of the message 666, the room controller 28 responds with a Media Session Setup Confirm message 668 and the media flows 670 is established between the encoder of room controller 26 and the decoder of room controller 28. The room controller 26 then proceeds the same way with the room controller 24 with message transactions 672 and 674, providing for the media establishment 676.

The room controller 28 initiates media session 678 with the room controller 24 by sending Media Session Setup Request message 680. The information regarding media session is attached to the message in a manner known in the art. Upon reception of the message 680, the room controller 24 responds with a Media Session Setup Confirm message 682 and the media flows 684 is established between the encoder of room controller 28 and the decoder of the room controller 24. The room controller 28 then proceeds the same way with room controller 26 with message transactions 686 and 688, providing for the media establishment 690.

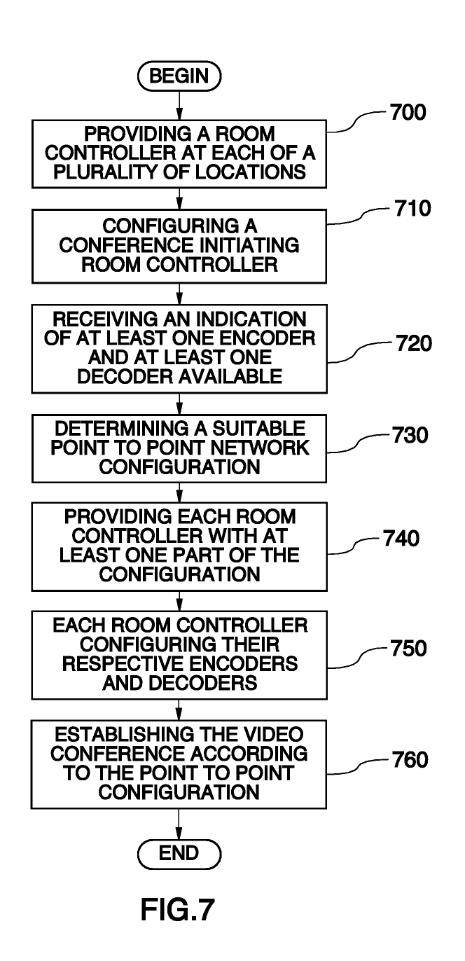

Now referring to FIG. 7, there is shown a method for establishing a multi-stream video conference between a plurality of locations.

According to processing step 700, a room controller is provided at each of the plurality of locations. Each room controller is controlling at least one of the local encoder for streaming an audiovisual signal towards at least one other location and at least one decoder for processing an incoming audiovisual stream from another location. In one embodiment, the room controllers are interconnected using a data network. In one embodiment, the data network comprises the Internet.

According to processing step 710, a conference initiating room controller is configured. The configuring of the conference initiating room controller comprises providing an indication of a selected set of locations to be interconnected.

According to processing step 720, the conference initiating room controller receives an indication of at least one of the corresponding at least one local encoder and the corresponding at least one local decoder associated with each location of the selected set of locations to be interconnected using the data network.

According to processing step 730, a suitable point-to-point network configuration is determined between the corresponding at least one local encoder available and the corresponding at least one decoder available for each of the controllers of the selected set of locations.

According to processing step 740, each room controller of the selected set of locations is provided with at least one part of the configuration.

According to processing step 750, each room controller of the selected set of locations is configuring their respective local encoders and decoders in accordance with the configuration.

According to processing step 760, the video conference is established according to the determined point-to-point network configuration.

It will be appreciated that the embodiments disclosed herein are examples of a method for dynamic establishment of multi-point telepresence conference wherein more than two sites are participating, wherein the protocol used may be Session Initiation Protocol and Session Description Protocol is used for room profile attachments and formats. Furthermore, the network model involves either standalone room controllers or integrated room controllers and associated encoders and decoders.

It will be further appreciated that there is disclosed a method for indirect connection of the participating room controllers and involved encoders and decoders in a multiparty conference, wherein the protocol used may be Session Initiation Protocol.

Moreover, the skilled addressee will appreciate that there is further disclosed a two-phase method used either in the integrated room controller or standalone room controller network model, wherein the dialog is being established between all room controllers involved in the conference in the first phase of the method and the media sessions are established between involved encoders and decoders either in the standalone room controller or integrated room controller network model in the second phase of the method.

According to another aspect of the invention, there is also provided a computer readable medium comprising computer readable instructions for causing a processing unit to carry out the method disclosed above. Preferably, the computer readable instructions provide a user interface for receiving the indication of the selected set of locations to be interconnected.

Although the above description relates to specific preferred embodiments as presently contemplated by the inventor, it will be understood that various modifications could be made to the embodiments described above without departing from the scope of the invention as defined in the appended claims.

We claim:

1. A method for establishing a multi-stream video conference between a plurality of locations, the method comprising:
providing a room controller at each of the plurality of locations, each room controller controlling at least one of at least one local encoder for streaming an audiovisual signal towards at least one other location and at least one decoder for processing an incoming audiovisual stream from another location wherein the room controllers are interconnected using a data network;
configuring a conference initiating room controller, the configuring comprising providing an indication of a selected set of locations to be interconnected;
the conference initiating room controller receiving an indication of at least one of the corresponding at least one local encoder and the corresponding at least one local decoder associated with each location of the selected set of locations to be interconnected using the data network;
determining a suitable point-to-point network configuration between the corresponding at least one local encoder available and the corresponding at least one decoder available for each of the controllers of the selected set of locations;
providing each room controller of the selected set of locations with at least one part of the configuration;
each room controller of the selected set of locations configuring at least one of their respective local encoders and decoders in accordance with the configuration; and
establishing the video conference according to the suitable point-to-point network configuration.

2. The method according to claim 1, wherein the point-to-point network configuration comprises a mesh network for supporting communication and establishment of media streams between each location of the selected set of locations.

3. The method according to claim 1, wherein the point-to-point network configuration comprises a star network for supporting communication and establishment of media streams between the conference initiating room controller and each location of the selected set of locations.

4. The method according to claim 1, further comprising reporting back a conference status indication to the conference initiating room controller.

5. The method according to claim 1, wherein the providing of each room controller with at least one part of the configuration is performed by the conference initiating room controller.

6. The method according to claim 1, further comprising:
detecting a request to disconnect the conference; and
upon receipt of the request to disconnect, disconnecting the conference and releasing the associated room controllers.

7. The method according to claim 1, wherein the data network comprises Internet and the room controllers are interconnected using a signaling communication protocol.

8. The method according to claim 1, wherein the at least one local encoder encodes media streams incoming from a corresponding audiovisual device into internet protocol based media streams and the at least one local decoder decodes the incoming internet protocol based media streams into output media streams provided to a corresponding audiovisual device.

9. A system for establishing a multi-stream video conference between a plurality of locations interconnected with a data network, said system comprising:
a plurality of local encoding means, each being respectively associated with a corresponding one of the plurality of locations for streaming a corresponding audiovisual signal towards at least one other location, each of said encoding means providing a first configuration indication on an available configuration of the associated location;
a plurality of local decoding means, each being respectively associated with a corresponding one of the plurality of locations for processing an incoming audiovisual stream from another location, each of said decoding means providing a second configuration indication on the available configuration of the associated location; and
a plurality of room controllers, a corresponding one of said controllers being associated with each corresponding location respectively, said plurality of room controllers comprising a conference initiating room controller adapted for receiving an indication of a selected set of locations to be interconnected and for communicating with at least one of the encoding means and the decoding means associated with each of the locations selected to receive the configuration indications of the associated location, the conference initiating room controller being further adapted to determine a suitable point-to-point network configuration based on the configuration indications for providing each of the remaining room controllers with at least a part of the configuration, each of the room controllers being adapted to control at least one of the corresponding local encoding means and decoding means of the associated location according to the suitable configuration so as to establish the video conference according to the suitable point-to-point network configuration.

10. The system according to claim 9, wherein said data network comprises Internet.

11. The system according to claim 9, wherein said encoding means comprises at least one encoder associated with a respective audiovisual device and wherein said decoding means comprises at least one decoder associated with a respective audiovisual device.

12. The system according to claim 9, wherein said conference initiating room controller comprises one of the controllers associated with one of the locations of the selected set of locations.

13. The system according to claim 9, wherein the room controller, the encoding means and the decoding means associated with the corresponding location are integrated in a single unit.

14. A computer readable medium comprising computer readable instructions for causing a processing unit to carry out the method of claim 1.

15. The computer readable medium according to claim 14, wherein said computer readable instructions provide a user interface for receiving the indication of the selected set of locations to be interconnected.
